(19) United States
(12) Patent Application Publication
(10) Pub. No.: US 2010/0037223 A1
(43) Pub. Date: Feb. 11, 2010

(54) METHOD FOR CONTROLLING STORAGE APPARATUS AND STORAGE APPARATUS

(75) Inventor: Keiichi Yorimitsu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/476,885

(22) Filed: Jun. 2, 2009

(30) Foreign Application Priority Data
Aug. 11, 2008 (JP) 2008-206829

(51) Int. Cl. G06F 9/46

(52) U.S. Cl. 718/100

(57) ABSTRACT

A method for controlling a storage apparatus includes rearranging an order of execution of commands supplied from an external apparatus and queued in the storage apparatus so as to optimize execution of commands, and adjusting a maximum retry time of a command on the basis of a passage time from receipt of the command, the maximum retry time being defined for each command. The adjusting includes at least one of a first adjustment and a second adjustment. The first adjustment reduces the maximum retry time of at least one of the commands queued in the storage apparatus on the basis of the passage time of said at least one of the commands at a first timing when the order of execution of commands is rearranged. The second adjustment reduces the maximum retry time of a selected command to be executed in the storage apparatus on the basis of the passage time of the selected command at a second timing before the selected command is executed in the storage apparatus.

### CROSS-REFERENCE TO RELATED APPLICATION

This application is based upon and claims the benefit of priority of the prior Japanese Patent Application No. 2008-206829, filed on Aug. 11, 2008, the entire contents of which are incorporated herein by reference.

### FIELD

A certain aspect of the embodiments discussed herein is related to a method for controlling a storage apparatus and a storage apparatus.

### BACKGROUND

A recent storage apparatus such as a magnetic disk drive uses a high-speed serial transfer interface such as ATA (ANSI T13/Serial ATA International Organization (SATA-IO)) as an interface with an upper apparatus such as a host computer. This type of interface is equipped with a command queuing function directed to reducing the process times (overheads) of the host and the magnetic disk drive. This function queues a command such as a write command or a read command issued by the host.

More particularly, the command queuing function stores read and write commands from the host in a queue in the magnetic disk drive in the order of issuance. In the hard disk drive, the commands are rearranged in the increasing order of medium access time. This is called reordering. Then, the commands are read out in the rearranged order and are executed in turn. When execution of each of the commands ends, the respective end statuses are immediately sent to the host. Thus, the host receives the end statues in the command execution ending order. More specifically, as illustrated in FIG. 10, the reordering rearranges the order of execution of commands so that data (LBA: Logical Block Address) closest to the head position that is located after a command in progress (here Read1) is executed is next processed.

The command queuing function has been reduced to practice as an apparatus-side function of the hard disk drive (not as an interface) using the parallel transfer interface proposed earlier than the high-speed serial transfer interface. The command queuing function presented as the apparatus-side function is the same as that presented as an interface in terms of queuing in the order of issuance of commands and rearranging in the increasing order of medium access time.

The host expects that execution of a command is completed within a given time after the command is issued. Thus, if execution of the command does not end within the given time, the host recognizes that a timeout occurs.

The queue time of multiple commands queued in the apparatus is the total of the times that the respective commands are selected and executed after the commands are received. For example, in the example illustrated in FIG. 10, command Read6 is the seventh order of execution. If command Read2 is being executed in the hard disk drive at the time when command Read6 is received, the queue time of command Read6 is the total of the remaining execution time of Read2, the execution time of Read5 and the execution time of Read3.

There is a proposal to suppress reduction of the total command throughput in a storage apparatus equipped with command queuing (see Japanese Laid-Open Patent Publication No. 2001-249770).

This proposal defines a limit on the number of times that a command is left behind another command that is received after the former command is received. The command left behind is preferentially executed when the present command is overtaken by the limited number of times. Further, the proposal manages the time when each command is received, and a command that has not been executed over a predetermined time upon receipt is preferentially executed.

However, the proposal has a problem arising from the following situation. When a retry for a command to be preferentially executed is frequently requested, a timeout occurs for another command to be subsequently executed. When the timeout occurs, the host executes a retry process for the command of concern. However, the overhead in the retry process may degrade the performance. At worst, the host may execute a process for disconnecting the storage apparatus from the host due to failure of the retry process.

### SUMMARY

According to an aspect, there is provided a method for controlling a storage apparatus including: rearranging an order of execution of commands supplied from an external apparatus and queued in the storage apparatus so as to optimize execution of commands; and adjusting a maximum retry time of a command on the basis of a passage time from receipt of the command, the maximum retry time being defined for each command, the adjusting including at least one of a first adjustment and a second adjustment, the first adjustment reducing the maximum retry time of at least one of the commands queued in the storage apparatus on the basis of the passage time of said at least one of the commands at a first timing when the order of execution of commands is rearranged, and the second adjustment reducing the maximum rety time of a selected command to be executed in the storage apparatus on the basis of the passage time of the selected command at a second timing before the selected command is executed in the storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a hard disk drive in accordance with an embodiment;

FIG. 2 illustrates a command processing sequence;

FIG. 3 is a flowchart of a process executed by an MPU between time A and time B illustrated in FIG. 2;

FIG. 4 is a flowchart of a process executed by the MPU at the time of reordering;

FIG. 5 shows exemplary cases where an initial value Tmax(retry) of a maximum retry time, an expected command execution time Texp and a command stack time Tcurr;

FIGS. 6A, 6B and 6C illustrate exemplary reordering;

FIGS. 7A and 7B illustrate effects of reordering in accordance with an embodiment;

FIGS. 8A and 8B illustrate other effects of reordering in accordance with an embodiment;

FIG. 9 is a flowchart of a process executed at the time of dequeuing; and

FIG. 10 illustrates a comparative example of reordering.

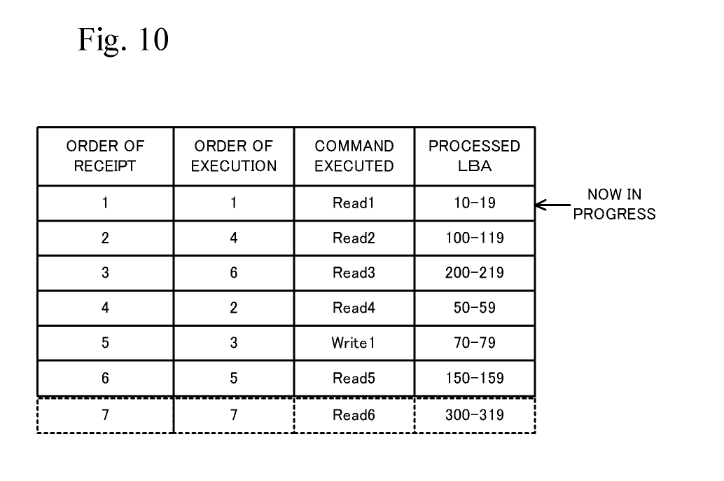

### DESCRIPTION OF EMBODIMENTS

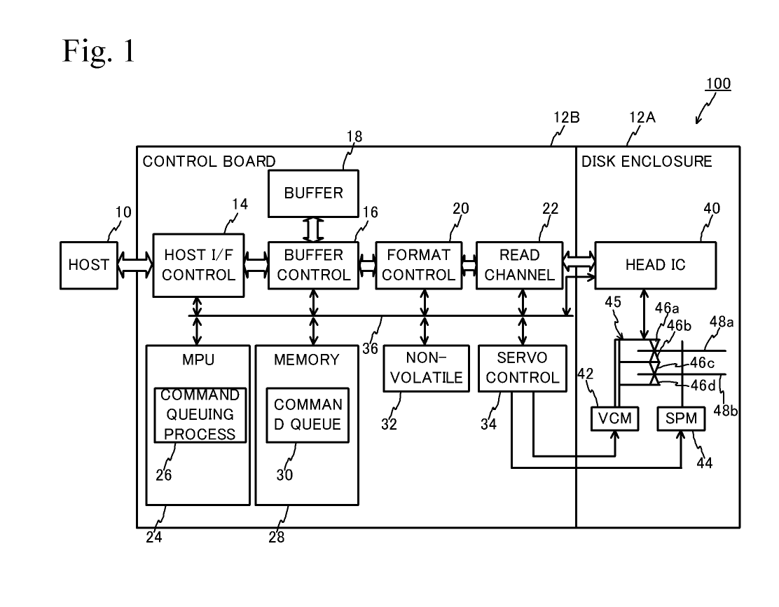

A storage apparatus in accordance with an embodiment will now be described with reference to FIGS. 1 through 9.

FIG. 1 is a block diagram of a hard disk drive (HDD) 100, which is an exemplary storage apparatus in accordance with an embodiment. The HDD 100 has a disk enclosure 12A and a control board 12B.

The disk enclosure 12A houses magnetic disks 48a and 48b, a spindle motor 44, a voice coil motor 42, an arm 45, heads 46a, 46b, 46c and 46d, and a head IC 40.

The spindle motor 44 holds the magnetic disks (storage media) 48a and 48b attached to a rotary shaft, and rotates the magnetic disks 48a and 48b at a constant velocity.

The voice coil motor 42 drives the arm 45. The heads 46a through 46d are mounted to an end portion of the arm 45 driven by the voice coil motor 42. The voice coil motor 42 moves the heads 46a through 46d by moving the arm 45, so that the heads 46a through 46d can be positioned over recording planes of the magnetic disks 48a and 48b.

Each of the heads 46a through 46d has a structure in which a write head and a read head are incorporated, and is connected to the head IC 40 by a signal line. The head IC 40 selects one of the heads 46a through 46d in response to a write command or a read command issued by a host 10 that is an upper apparatus, and performs a write or read operation using the selected head.

The head IC 40 includes a write amplifier in a write system and a read amplifier in a read system.

The control board 12B includes a MPU (microprocessor unit) 24 and structural elements connected to a bus 36 of the MPU 24. These structural elements include a random access memory 28, a non-volatile memory 32, a host interface control unit 14, a buffer memory control unit 16, a format control unit 20, a read channel 22 and a servo control unit 34. The buffer memory control unit 16 controls a buffer memory 18. The format control unit 20 functions as a hard disk controller.

The memory 28 temporarily stores control programs and control data The non-volatile memory 32 may, for example, be a ROM and stores control programs. The read channel 22 functions a write modulator and a read demodulator. The servo control unit 34 controls the voice coil motor 42 and the spindle motor 44.

In the HDD 100 thus configured, an input or output process (input/output process) is executed when a write command or a read command from the host 100 is received as an input or output command. The input/output process utilizes the command queuing function presented as native command queuing of a high-speed serial transfer interface such as serial ATA used to make a connection between the host and the host interface control unit 34.

In order to realize the command queuing function provided by the high-speed serial transfer interface, the present embodiment employs a command queuing unit 26 implemented in the MPU 24 as an optimizing unit and an adjustment unit, and the memory 28 has a command queue 30. The command queuing unit 26 stores input/output commands such as write commands and read commands issued by the host in the command queue 30 in the order of issuance, and performs reordering in the increasing order of access time. The MPU 24 takes the reordered commands from the command queue 30, and informs the host 10 of completion of execution of the commands soon after execution of the respective commands is completed. For example, the command queue 30 may stack 128 commands.

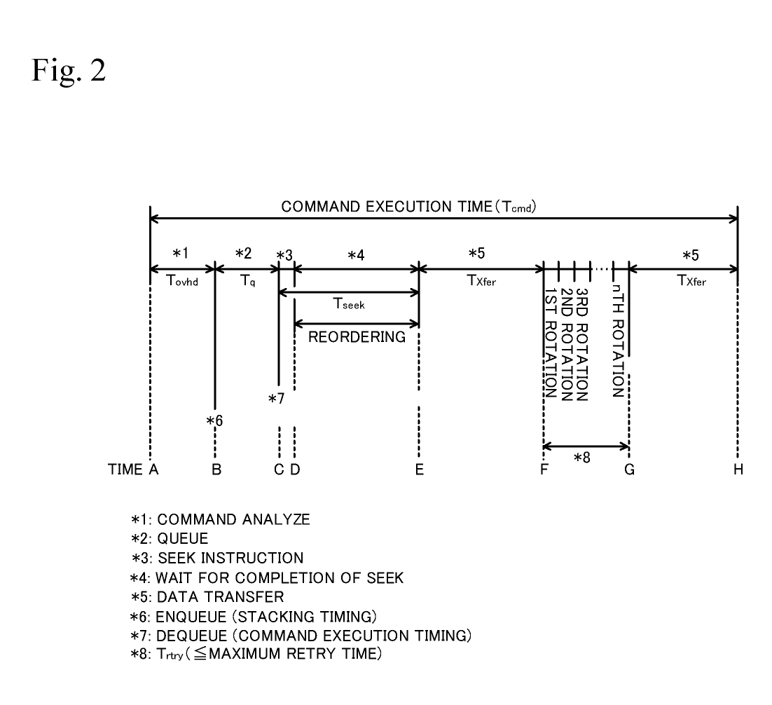

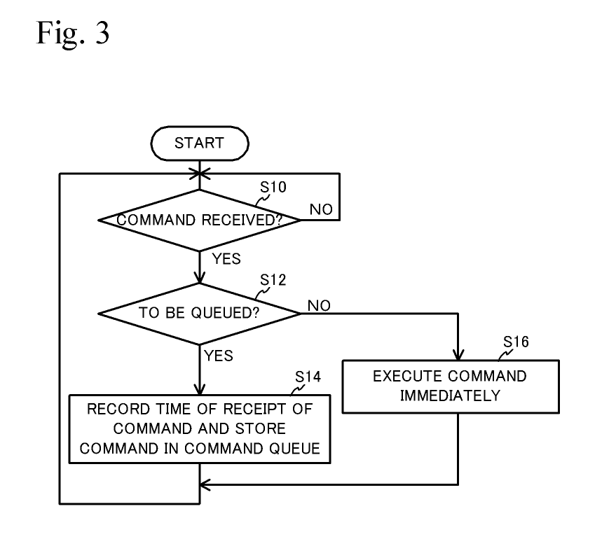

A description will now be given, with reference to FIGS. 2 through 6, of a sequence of processing commands (read commands in the present example) in the HDD 100. FIG. 3 is a flowchart of command analyzing and queuing performed at time A to time B depicted in FIG. 2.

At time A in FIG. 2, a command (now named command CMDn) is applied from the host 10. The host interface control unit 14 receives the command CMDn (step S10 in FIG. 3). The command queuing unit 26 of the MPU 24 analyzes the command CMDn. In FIG. 2, the time it takes to analyze the command CMDn is denoted as Tovhd.

In the command analyzing, it is determined whether the command CMDn should be queued at step S12. When the answer of step S12 is NO, that is, when the command CMDn should not be queued, the MPU 24 executes the command CMDn immediately. In contrast, when the answer of step S12 is YES, at step S14, the command queuing unit 26 records the time of receipt of the command CMDn (time A), and stores the command CMDn in the command queue 30 (enqueuing).

After the above enqueuing, when a given time (Tq) passes and the current time is a command execution timing (time C), the MPU 24 takes one of the commands in the command queue 30 (dequeuing). Then, the MPU 24 issues a seek instruction to the servo control unit 34 on the basis of the address of the dequeued command. The servo control unit 34 drives the voice coil motor 42 and the spindle motor 44 on the basis of the seek instruction (see time D in FIG. 2). The time it takes to issue the seek instruction and complete the execution of the seek instruction is denoted by Tseek in FIG. 2.

In the present embodiment, the reordering is carried out during the time when the seek operation is being executed (time D to Time E). The detailed manner of the reordering will be described in detail later.

Turning back to FIG. 2, the MPU 24 reads data from the magnetic disk 48a or 48b via the read channel 22 and the head IC 40. In FIG. 2, the time it takes to read data is denoted as a data transfer time Txfer. When the reading of data is successful, the MPU 24 transfers the read data to the host 10 (between times G and H). In contrast, if the reading of data is faulty, a retry is carried out. In FIG. 2, a retry time is denoted as Trtry.

In the present embodiment, the maximum time during which a retry is allowed for each command is defined. This time is called maximum retry time. The maximum retry time may be defined by a predetermined initial value Tmax(retry) only and may vary with the passage of time. The detail of the maximum retry time will be described in detail later.

During the command execution time Tcmd, the process depicted in FIG. 2 executes the command analyzing, queuing, seek instruction, waiting for seek completion, data transfer and retry (as necessary). Thus, the command execution time Tcmd may be described by expression (1):

Tcmd=Tovhd+Tq+Tseek+Txfer+Trty (1)

The above description is exemplarily related to the case where the command that the MPU 24 receives from the host 10 is a read command. A process similar to the above-described process is executed for a write command.

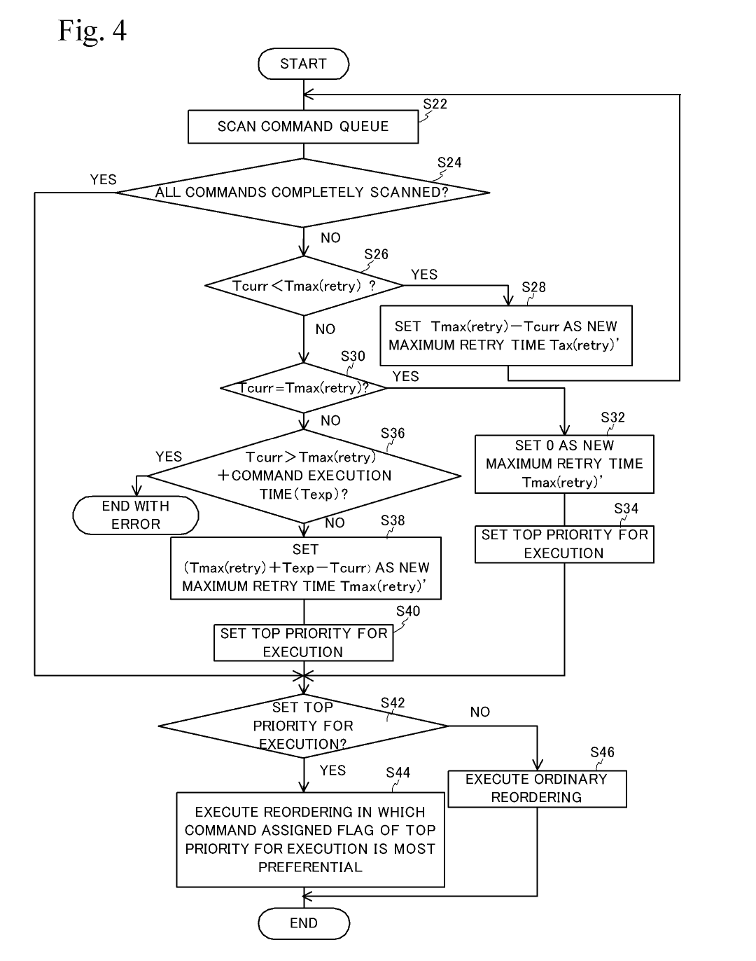

The reordering process in the present embodiment to optimize the order of execution of comments will now be described with reference to FIG. 4.

In the reordering process, the command queuing unit 26 scans the command queue 30 at step S22. Here, “scan” means that the command queuing unit 26 selects one of the commands included in the command queue 30 as a command to be concerned. At subsequent step S24, the command queuing unit 26 determines whether all of the commands in the command queue 30 have been completely scanned. Here, only one command is scanned. Thus, the answer of step S24 is NO, and the process proceeds to step S26.

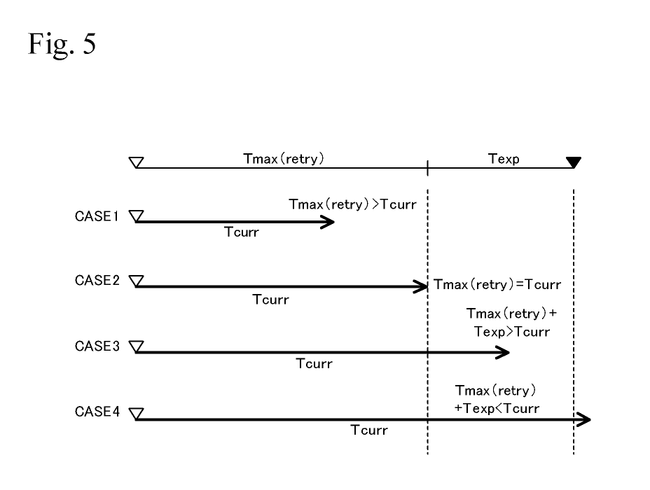

At step S26, the command queuing unit 26 determines whether the command stack time of the command to be concerned is less than the initial value Tmax(retry) of the predetermined maximum retry time. The command stack time is the time Tcurr that has passed upon receiving the command to be concerned. An exemplary case where the result of step S26 is YES is case 1 in FIG. 5. A time Texp illustrated in FIG. 5 denotes an expected command execution time (fastest execution time) and may be described by expression (2):

Texp=Tseek+Tovhd+Txfer (2)

When the answer of step S26 is YES, at step S28, the command queuing unit 26 sets the new or updated maximum retry time Tmax(retry)′ to Tmax(retry)−Tcurr, and returns to step S22. That is, the command queuing unit 26 defines, as the maximum retry time, the time obtained by subtracting the stack time (passage time) from the initial value of the maximum retry time, and scans another new command in the command queue 30.

In contrast, when the answer of step S26 is NO, the command queuing unit 26 proceeds to step S30, and determines whether the command stack time Tcurr is equal to the initial value Tmax(retry) of the maximum retry time. An exemplary case where the answer of step S30 is YES is case 2 in FIG. 5.

When the answer of step S30 is YES, at step S32, the command queuing unit sets Tmax(retry)−Tcurr as the updated retry time Tmax(retry)′ as in the case of step S28. Here, since Tmax(ertry)=Tcurr, Tmax(retry)′ is set equal to zero. That is, the retry is prohibited. At subsequent step S34, the MPU 24 sets or activates a flag indicative of top priority for execution and proceeds to step S42.

In contrast, when the answer of step S30 is NO, the command queuing unit 26 proceeds to step S36 and determines whether the command stack time Tcurr is greater than the sum of the initial value Tmax(retry) of the maximum retry time and the expected command execution time Texp (Tcurr>Tmax(retry)+Texp). An exemplary case where the answer of step S36 is affirmative is case 4 illustrated in FIG. 5. In contrast, an exemplary case where the answer of step S36 is negative is case 3 illustrated in FIG. 5. When the answer of step S36 is YES (case 4), a timeout inevitably takes place even when the command being processed is executed. Thus, the process for the present command is terminated with error.

At step S38, the command queuing unit 26 sets Tmax(retry)+Texp−Tcurr as the updated maximum retry time Tmax(retry)′, and sets the flag of top priority for execution.

In case 3 illustrated in FIG. 5, the command stack time Tcurr is greater than the initial value Tmax(retry) of the maximum retry time, and enters into the expected command execution time Texp. Thus, it seems that a timeout inevitably takes place even when the present command is executed like case 4. However, the expected command execution time Texp is described as Texp=Tseek+Tovhd+Txfer, which has been described as expression (2). If the seek time Tseek can be reduced by changing the order of execution of commands, the expected command execution time Texp can be reduced, and the timeout may be avoided. With the above in mind, according to an aspect of the present embodiment, even when there is a command like case 3 in the reordering process, the present command is not always handled as termination with error.

The process proceeds to step S42 when any of three cases (i) all the commands satisfy Tcurr<Tmax(retry) and the answer of step S24 is YES, (ii) a certain command satisfies Tcurr=Tmax(retry) and the flag of top priority for execution is set at step S34, and (iii) a certain command satisfies Tmax(retry)<Tcurr<Tmax(retry)+Texp and the flag of top priority for execution is set at step S42.

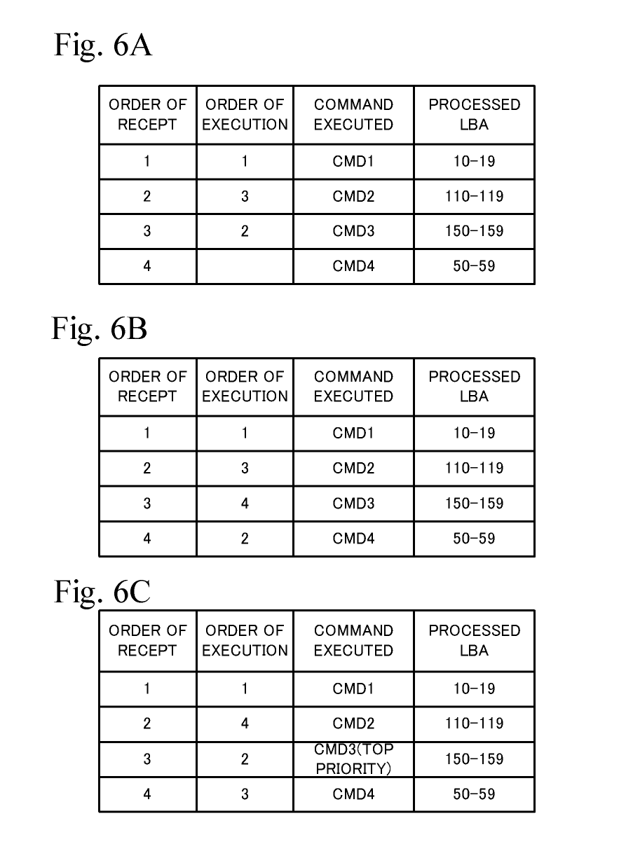

At step S42, the command queuing unit 26 determines whether the flag of top priority for execution has been set. In the above-described case (i) (the answer of step S24 is YES), the answer of step S42 is NO. In this case, the ordinary reordering is carried out at step S46. More specifically, as illustrated in FIG. 6A, it is assumed that 20 command CMD4 is received in a state in which the commands CMD1-CMD3 are queued (and command CMD1 is being executed) and the flag of top priority for execution is set to command CMD3. In this case, in the next reordering, as illustrated in FIG. 6B, the commands are rearranged in the LBA order (CMD1→CMD4→CMD2→CMD3).

In cases (ii) and (iii) (cases via step S34 or step S40), the answer of step S42 is YES. In these cases, the process proceeds to step S44 at which reordering is carried out in such a manner that the command to which the flag of top priority for execution is set is most preferential. For example, as depicted in FIG. 6A, it is assumed that command CMD4 is received in a state in which the commands CMD1-CMD3 are queued (and command CMD1 is being executed) and the flag of top priority for execution is set to command CMD3. In this case, in the next reordering, the order of command CMD3 is given top priority irrespective of LBA, and the commands are rearranged in the order of CMD1→CMD3→CMD4→CMD2, as illustrated in FIG. 6C.

The process illustrated in FIG. 4 ends when the reordering at step S44 or step S46 is completed as described above.

The present embodiment executes the process illustrated in FIG. 4 so that the maximum retry time can be changed dynamically at steps S28, S32 and S38 and the flag of top priority for execution is set based on the maximum retry time to process the command to which the flag of top priority for execution is set. This results in the following effects.

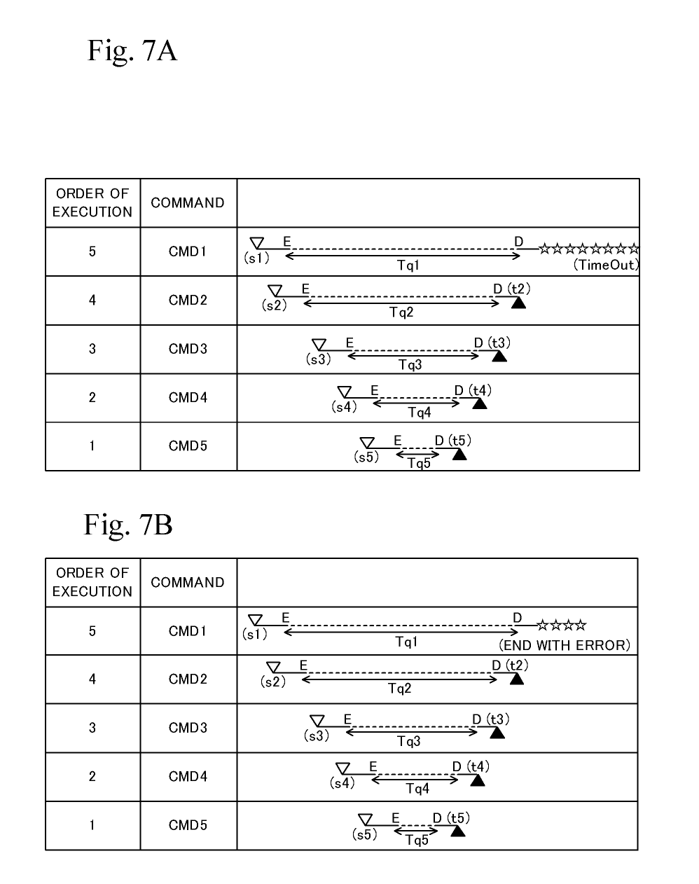

For example, as illustrated in FIG. 7A, it is assumed that reordering prior to execution of command CMD5 defines the execution order of CMD5→CMD4→CMD3→CMD2→CMD1. In this order, the commands are executed while the maximum retry time is the initial value. In this case, a timeout takes place when the retry process for command CMD1 is repeatedly carried out eight times. In FIG. 7A, one retry process is indicated by one star symbol. In contrast, according to the present embodiment, the maximum retry time is changed (reduced) based on the command stack time Tcurr. Thus, as illustrated in FIG. 7B, command CMD1 is forcedly terminated with error when the retry process for command CMD1 is repeatedly carried out four times. That is, command CMD1 is terminated with error before a timeout takes place actually. This makes it possible for the HDD100 to report the host 10 of error. A fault analysis on the host side may be executed and a factor that causes the error can be identified. It is to be noted that the fault analysis is not carried out when a timeout takes place.

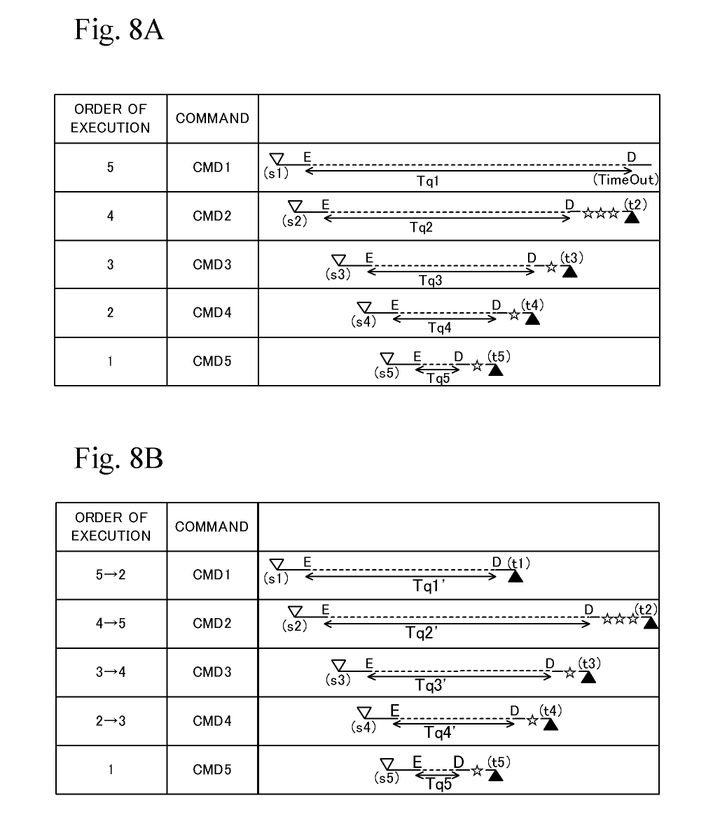

For example, as illustrated in FIG. 8A, when a timeout for command CMD1 is about to take place at the stage of executing command CMD5, in other words, when the maximum retry time becomes zero as in the case of step S32, the present embodiment sets the flag of top priority for execution of command CMD1. In this case, as illustrated in FIG. 8B, the order of execution of command CMD1 is given top priority, so that a timeout of command CMD1 and other commands can be avoided.

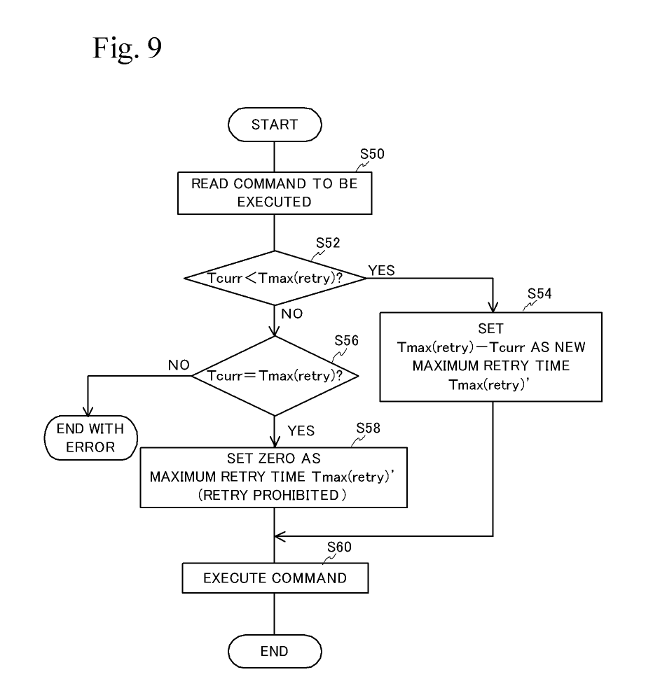

Dequeuing (command execution timing (time C in FIG. 2)) will now be given with reference to FIG. 9.

The MPU 24 reads the command to be executed at step S50 in FIG. 9, and determines whether the expected command execution time Tcurr is smaller than the initial value Tmax(retry) of the maximum retry time.

When the answer of step S52 is YES (case 1 in FIG. 5), at step S54, the 20 command queuing unit 26 sets Tmax(retry)−Tcurr as the updated maximum retry time (Tmax(retry)′) as in the case of step S28 shown in FIG. 4. Then, the MPU 24 executes the command to be executed at step S60. In contrast, when the answer of step S52 is NO, the process proceeds to step S56.

At step S56, the MPU 24 determines whether the command stack time Tcurr is equal to the initial value Tmax(retry) of the maximum retry time. When the answer of step S56 is YES (case 2), the process proceeds to step S58.

At step S58, zero is written in Tmax(retry)′ as in the case of step S32 in FIG. 4. That is, the retry process is prohibited. Then, the MPU 24 executes the command at step S60 in the state in which the retry process is prohibited.

In contrast, when the answer of step S56 is NO (cases 3 and 4 in FIG. 5), the minimum time necessary to execute the command (expected command execution time Texp) is not available. This is because the command stack time Tcurr enters in the expected command execution time Texp. Thus, the command to be executed is forcedly terminated with error, and the host 10 is thus informed of termination with error.

As described above, the dequeuing executes the process of adjusting the maximum retry time, so that the command can be executed with the appropriate maximum retry time in dequeuing. This makes it possible to restrain the occurrence of timeout of execution of command. Further, the command is forcedly terminated with error prior to execution of the command as in the case of the process executed at step S56. It is thus possible to avoid execution of the command having a high possibility of timeout and to efficiently execute the commands.

As described above, according to the present embodiment, in the reordering, the maximum retry time of at least one of the commands stacked in the queue is adjusted (or reduced) on the basis of the passage time from the receipt of the present command. It is thus possible to restrain the occurrence of timeout at the time of executing the command. According to the present embodiment, in the dequeuing for execution of the command, the maximum retry time of at least one of the commands stacked in the queue is adjusted (or reduced) on the basis of the passage time from the receipt of the present command. The command is forcedly terminated with error prior to the occurrence of timeout, so that the host 10 can be informed of the error report. It is thus possible for the host 10 to analyze the error and identify the factor that causes the error.

At the time of reordering, the present embodiment preferentially executes the command of the command stack time Tcurr is equal to or greater than the initial value Tmax(retry) of the maximum retry time. It is thus possible to restrain the occurrence of timeout by preferentially executing the command for which the maximum retry time is no longer secured.

In the present embodiment, when the command stack time does not exceed the initial value Tmax(retry) of the maximum retry time, the command queuing unit 26 updates the maximum retry time by subtracting the stack time Tcurr from the initial value Tmax(retry) of the maximum retry time. It is thus possible to appropriately define the maximum retry time by simple computation.

The present embodiment forcedly error-terminates the command having the command stack time Tcurr that exceeds the sum of the initial value Tmax(retry) of the maximum retry time and the command execution time Texp. It is thus possible to avoid a situation in which a timeout of a command inevitably takes place nevertheless the retry of this command is repeatedly performed until the timeout actually takes place and to efficiently execute the commands.

In the dequeuing (at the time of executing a command), the present embodiment forcedly error-terminates the command when this command to be executed has the command stack time Tcurr greater than the initial value Tmax(retry) of the maximum retry time. In this regards, the commands can be executed efficiently.

The present embodiment adjusts the maximum retry time at the time of reordering and dequeuing. Alternatively, the maximum retry time may be adjusted at the time of either reordering or dequeuing.

The present embodiment carries out both the adjustment of the maximum retry time and the setting of the command given top priority for execution on the basis of the relation between the maximum retry time and the command stack time. Besides, only the adjustment of the maximum retry time may be employed.

Generally, each of the commands has the respective different initial value Tmax(retry) of the maximum retry times and the expected command execution times Texp. However, some or all of the commands may have an identical initial value Tmax(retry) of the maximum entry times and an identical expected command execution time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method for controlling a storage apparatus comprising:
rearranging an order of execution of commands supplied from an external apparatus and queued in the storage apparatus so as to optimize execution of commands; and
adjusting a maximum retry time of a command on the basis of a passage time from receipt of the command, the maximum retry time being defined for each command,
the adjusting including at least one of a first adjustment and a second adjustment,
the first adjustment reducing the maximum retry time of at least one of the commands queued in the storage apparatus on the basis of the passage time of said at least one of the commands at a first timing when the order of execution of commands is rearranged, and
the second adjustment reducing the maximum retry time of a selected command to be executed in the storage apparatus on the basis of the passage time of the selected command at a second timing before the selected command is executed in the storage apparatus.

2. The method according to claim 1, further comprising updating the maximum the maximum retry time defined by subtracting the passage time from an initial value of the maximum retry time in the first and second adjustments when the passage time does not exceed the initial value of the maximum retry time.

3. The method according to claim 1, wherein the rearranging includes obtaining the passage time of a specific command from among the commands queued in the storage apparatus, and giving top priority for execution to the specific command when the passage time of the specific command is equal to or longer than an initial value of the maximum retry time.

4. The method according to claim 1, further comprising error-terminating a specific command when the specific command from among the commands exceeds a sum of an initial value of the maximum retry time and a command execution time necessary to execute the specific command at the first timing.

5. The method according to claim 1, further comprising error-terminating the selected command to be executed when the passage time of the selected command to be executed exceeds an initial value of the maximum retry time at the second timing.

6. A storage apparatus comprising:
a first part configured to rearrange an order of execution of commands supplied from an external apparatus and queued in the storage apparatus so as to optimize execution of commands; and
a second part configured to adjust a maximum retry time of a command on the basis of a passage time from receipt of the command, the maximum retry time being defined for each command,
the second part executing at least one of a first adjustment and a second adjustment,
the first adjustment reducing the maximum retry time of at least one of the commands queued in the storage apparatus on the basis of the passage time of said at least one of the commands at a first timing when the order of execution of commands is rearranged, and
the second adjustment reducing the maximum rety time of a selected command to be executed in the storage apparatus on the basis of the passage time of the selected command at a second timing before the selected command is executed in the storage apparatus.
